(19) United States
(12) Patent Application Publication
(10) Pub. No.: US 2002/0138589 A1
(43) Pub. Date: Sep. 26, 2002

(54) System and method for service caching on-demand

(76) Inventors: Binnur Al-Kazily, Star, ID (US); Craig R. White, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/814,266

(22) Filed: Mar. 21, 2001

(51) Int. Cl. G06F 15/16

(52) U.S. Cl. 709/217; 709/203

(57) ABSTRACT

A system and method is provided for locally storing on a local Point Of Presence (POP) an online service hosted on a remote host computer. The method includes providing a local point of presence for receiving a request to access an online service, and determining if the requested online service is locally stored on the local point of presence. The method also includes, in response to determining that the requested online service is not locally stored, downloading at the local point of presence the requested online service from a remote host computer hosting the requested online service and storing the downloaded online service on the local point of presence. The system includes a service caching system coupled to a POP and a POP cache. The POP receives a request to access an online service. The service caching system determines if the requested online service is locally stored in the POP cache. The service caching system downloads the requested online service from a remote host computer hosting the requested online service if the online service is not stored in the POP cache. The service caching system then stores the downloaded online service in the POP cache.

### BACKGROUND

1. Field

The present invention relates generally to on-line services and, more particularly, to electronic services on the Internet.

2. Description of the Related Art

Recent advances in computing and communication technology, coupled with the increasing percentage of the population with access to a computer (i.e., a personal computer), is fueling the rapid acceptance and growth of the Internet. One indication of the Internet's rapid acceptance and growth is the increasing amount of information and services (e.g., on-line services, electronic services, etc.) that are accessible through the Internet.

Typically, a user uses his or her personal computer to access the information and services available on the Internet. For example, a user executes a software program, commonly known as a “browser,” on his or her personal computer in order to access the Internet. The browser typically accesses the Internet through a local Point of Presence (POP) access point, such as, by way of example, a dial-up Internet Service Provider (ISP) connection or a broadband connection. Once connect to the local POP, the browser provides its user access to the vast amount of information and services available on the Internet.

The information and services are typically “hosted” on computer systems that are located at a location remote from the user's personal computer. For example, a user located in Los Angeles may be accessing a service hosted on a computer located in New York. In contrast, the local POP utilized by the user to access the Internet may be at a physical location that is much closer to the personal computer. For example, the local POP may be located in Los Angeles. Thus, accessing the information and services on the Internet may require a lengthy network connection, both in terms of physical distance and time.

A drawback to the Internet's continued acceptance and growth is that the connection between the local POP and the remote computer hosting the information or service may become a bottleneck. For example, network traffic is likely to increase proportionally to the amount of information and services available on the Internet as well as with the increase in the number of users accessing the information and services on the Internet. The increase in Internet traffic currently results in the users experiencing performance delays in accessing the information and services.

Accordingly, a need exists for improved network performance as more and more users continue to access the information and services on the Internet. Moreover, a need exists to reduce the performance delays currently experienced by Internet users.

### SUMMARY

The present disclosure is directed to a system and corresponding methods that facilitate the downloading and storing of remotely hosted online services on a local POP. The local POP receives a request to access an online service. The local POP determines if the requested online service is locally stored, and if not, downloads and locally stores the requested online service from a host computer over a network (e.g., Internet).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for caching an online service on a local point of presence, the online service being hosted on a remote host computer, includes: receiving a request, at a local point of presence, to access an online service; determining if the requested online service is locally stored on the local point of presence; in response to determining that the requested online service is not locally stored, downloading the requested online service from a remote host computer hosting the requested online service; and storing the downloaded online service on the local point of presence.

In another embodiment, computer-readable storage medium has stored thereon computer instructions that, when executed by a computer, cause the computer to: receive a request to access an online service; determine if the requested online service is locally stored on a local point of presence; in response to determining that the requested online service is not locally stored, download the requested online service from a remote host computer hosting the requested online service to the local point of presence; and store the downloaded online service on the local point of presence.

In still another embodiment, a service caching system for locally storing a requested online service, the online service being hosted on a remote host computer, includes: a means for maintaining a record of a plurality of online services locally stored on a local point of presence; a means for receiving a request to access an online service; a means for determining if the requested online service is locally stored on the local point of presence; in response to determining that the requested online service is not locally stored, a means for downloading the requested online service from a remote host computer hosting the requested online service; and a means for storing the downloaded online service on the local point of presence.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 is a diagram illustrating an environment in which a system of the present invention may operate.

FIG. 2 is a representation of one embodiment of an exemplary service cache record.

FIG. 3 illustrates a flow chart of an exemplary method by which a service is accessed, according to one embodiment.

FIG. 4 illustrates a flow chart of an exemplary method by which service caching is manually configured, according to one embodiment.

FIG. 5 illustrates a flow chart of an exemplary method of aging a cached service, according to one embodiment.

FIG. 6 illustrates a flow chart of an exemplary method for updating a cached service, according to one embodiment.

FIG. 7 is a representation of one embodiment of an exemplary cache directory record.

### DETAILED DESCRIPTION

A service caching system and corresponding methods, according to an embodiment of the present invention, facilitates on-demand caching of electronic or online services (e.g., computer services) provided on remote hosts. Electronic services, services, and online services are used interchangeably herein. The cached online services may then be accessed and executed on the service caching system. “Host” here generally refers to the infrastructure (e.g., hardware, software, and communication lines) that stores and offers the electronic or online service.

In one embodiment, the service caching system functionality may be implemented on, or as part of, a POP access point. The POP access point can be, for example, a dial-up Internet Service Provider (ISP) connection or a broadband connection. For example, ISPs generally provide many POPs so that users can make a local call to gain access to a network, such as, by way of example, the Internet. Here, the POP generally functions to provide the service caching system functionality as well as access to the Internet.

For example, an application or device (e.g., a browser executing on a personal computer) initiates a request to access an online service on the Internet through a local POP access point. The online service is made available on an Internet host (e.g., a computer connected to the Internet). The POP, and in particular, the service caching system component of the POP, looks in, for example, a service cache database for the requested online service. If the requested online service is cached on the POP (e.g., online service is locally stored on the POP's cache memory), the POP executes (i.e., provides access to) the online service out of the cache. If the requested online service is a “cacheable” service but is not currently cached, the POP downloads the online service from the remote host providing the online service. Once the online service is downloaded onto the POP cache memory, the online service is executed from the cache.

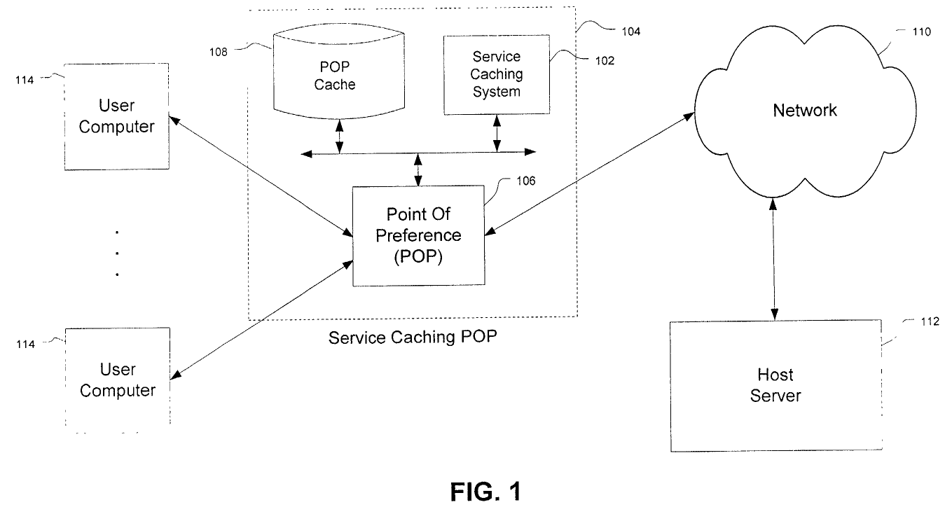

Embodiments of the present invention are understood by referring to FIGS. 1-7 of the drawings. Throughout the drawings, components that correspond to components shown in previous figures are indicated using the same reference numbers.

### Nomenclature

The detailed description that follows is presented largely in terms of processes and symbolic representations of operations performed by conventional computers, including computer components. A computer may be any microprocessor or processor (hereinafter referred to as processor) controlled device such as, by way of example, personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof The computer may possess input devices such as, by way of example, a keyboard, a keypad, a mouse, a microphone, or a touch screen, and output devices such as a computer screen, printer, or a speaker. Additionally, the computer includes memory such as a memory storage device or an addressable storage medium. The computer may be equipped with a network communication device such as a network interface card, a modem, or other network connection device suitable for connecting to one or more networks.

The computer may be a uniprocessor or multiprocessor machine. Additionally the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as, by way of example, read-only memory (ROM).

### Service Caching System

Referring now to the drawings, FIG. 1 illustrates an environment in which a service caching system 102 according to one embodiment may operate. The service caching system 102 may be implemented as a component of a service caching POP 104 that also includes a POP 106 connected to a POP cache 108. The service caching system 102 is connected to the POP 106 and POP cache 108. As depicted, the environment of FIG. 1 includes the service caching POP 104, a data network (e.g., the Internet) 110, and a host server 112. The service caching POP 104 and the host server 112 are connected to the Internet 110. The environment also includes one or more user computers 114 connected to the service caching POP 104. As used herein, the terms “connected,” “coupled,” or any variant thereof, means any connection or coupling, either direct or indirect, between two or more elements; the coupling or connection between the elements can be physical, logical, or a combination thereof.

As used herein, the terms “service caching system,” “service caching POP,” and “host server” are to be viewed as designations of one or more computers and are not to be otherwise limiting in any manner. The computers for the service caching system and service caching POP may be the same or different. The service caching system 102 may, for example, be comprised of one or more modules that execute on one or more computers. The host server 112 need not be server based, but can comprise one or more modules that execute on one or more computers.

The service caching system 102 facilitates the on-demand caching of remotely hosted online services. In one embodiment, the service caching system 102 is implemented as a component of the service caching POP 104, and may interact with other components of the service caching POP 104 to provide the on-demand caching of online services. Thus, a provider or operator of the service caching POP 104 may administer the service caching system 102.

In one embodiment, service caching system 102 contains program logic that conforms to and supports Hewlett-Packard Company's (HP's) e-speak specifications. E-speak specifies an open software platform designed for the development, deployment, and interaction of online services. The open software platform includes HP's Service Framework Specification (SFS) and HP's Service Engine. The SFS defines standard business interactions and conventions, such as, by way of example, XML documents, that allow e-speak compliant online services (e-services) to dynamically discover and negotiate with other e-services. These e-services may additionally compose themselves into more complex services. Thus, the e-speak specifications provide a framework that allows the SFS-compliant e-services to dynamically collaborate with any other compliant e-service.

The Service Engine is a software implementation of the SFS that performs the primary e-speak functions of discovery, negotiation, meditation, composition, and security. The Service Engine performs the intelligent interaction of e-services. The Service Engine implements business collaboration conventions expressed as both Java and XML application program interfaces (APIs). Additional information regarding e-speak can be obtained from Hewlett-Packard Company of Palo Alto, Calif.

The service caching system 102, being e-speak compliant, provides an environment suitable for executing one or more e-speak compliant e-services. Those of ordinary skill in the art will appreciate that other specifications may provide for the development of similar features and functions as HP's e-speak specifications. Here, the service caching system 102 may comply with, and support these other similar specifications, thus, providing an environment suitable for executing online services that are conformant to these specifications.

The service caching POP 104 includes the service caching system 102, the POP 106, and the POP cache 108. The service caching POP 104 generally functions to provide connectivity between one or more user computers 114 and the Internet 110 (provided for by the POP 106), as well as the on-demand caching of e-services (provided for by the service caching system 102). The POP 106 includes the hardware and software components needed to provide the connectivity to the Internet 110. The POP cache 108 is a storage mechanism that can either be, for example, a reserved section of main memory or an independent high speed storage device (e.g., SRAM, DRAM, etc.). The POP cache 108 may store the data, information, and program logic necessary to facilitate the service caching POP 104 functions, and the one or more downloaded e-services.

The Internet 110 is a global network connecting millions of computers, including the service caching POP 104. The structure of the Internet 110, which is well known to those of ordinary skill in the art, is a global network of computer networks and utilizes a simple, standard common addressing system and communications protocol known as Transmission Control Protocol/Internet Protocol (TCP/IP). The connections between different networks are called “gateways,” and the gateways serve to transfer electronic data worldwide.

One of ordinary skill in the art will appreciate that the Internet 110 may advantageously be comprised of one or a combination of other types of networks without detracting from the scope of the invention. The Internet 110 can include, by way of example, local area networks (LANs), wide area networks (WANs), public internets, private intranets, a private computer network, a secure internet, a private network, a public network, a value-added network, interactive television networks, wireless data transmission networks, two-way cable networks, satellite networks, interactive kiosk networks, and/or any other suitable data network.

The host server 112 may be an Internet host that provides one or more online services, such as, by way of example, an electronic business card service, an electronic travel reservation service, an electronic retail service, and the like, on the Internet 110. In one embodiment, the host server 112 conforms to HP's e-speak specifications, and thus, provides one or more e-services. For example, the electronic business card service, the electronic reservation service, and the electronic retail service is developed utilizing HP's SFS and Service Engine. Thus, host server 112 can host one or more e-services that may, in whole or in part, be downloaded to, and executed on the service caching POP 104.

In another embodiment, host server 112 may store and serve web pages, such as HTML documents, capable of displaying textual and graphical information on a computer screen. These computers are generally referred to as “websites.” The host server 112 may additionally host online services that are provided on the Internet 112. The online services may conform to one or more specifications (e.g., specifications similar to HP's e-speak) that enable the online services to be downloaded to, and executed on the service caching POP 104, similar to how web pages are downloaded from hosts onto client computers.

For example, a user executes a client application, such as a browser, on his or her user computer 114 to access the e-services hosted on host server 112 through the service caching POP 104. The browser is a software program that allows the user to connect to the Internet 110 through, for example, the service caching POP 104 and access different computers, including the host server 112, connected to the Internet 110.

In one embodiment, the browser may be a standard browser such as the Netscape Navigator® developed by Netscape, Inc., the Microsoft Internet Explorer® developed by Microsoft Corporation, a WebTV, an embedded web browser on a handheld device, or the like. In another embodiment, other types of access software, such as, by way of example, other types of Internet browsers, custom network browsers, communication software, cable modem software, point-to-point software, multi-point software, custom emulation software, and the like, could be used to implement the browser.

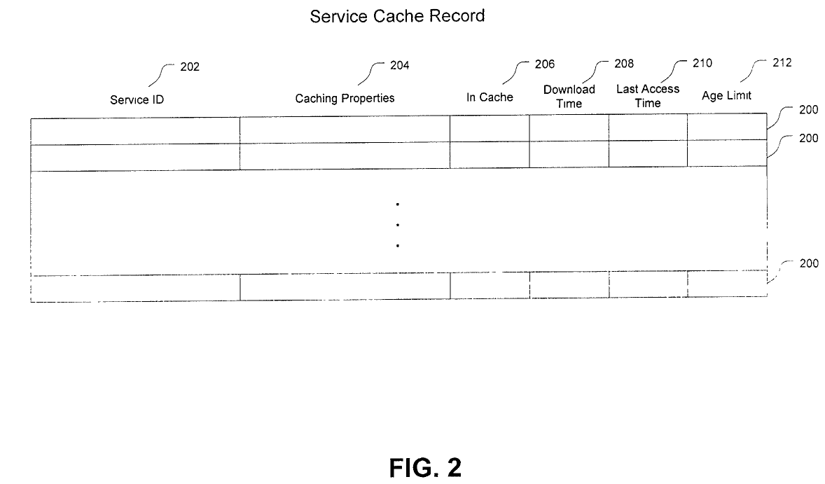

FIG. 2 is a representation of one embodiment of an exemplary service cache record 200. The service caching POP 104 may maintain information and data regarding one or more e-services (i.e., the online services that can be downloaded onto and executed from the service caching POP 104) in one or more service cache records 200. By way of example, six fields are illustrated in each service cache record 200 comprising a service ID 202, a caching properties 204, an in cache 206, a download time 208, a last access time 210, and an age limit 212. One of ordinary skill in the art will realize that, for this record or any other record described herein, any number of the fields may be broken down into additional sub-fields, that additional fields can be added, and that the fields may refer to other fields or other data records.

In one embodiment, the service ID 202 field identifies a particular e-service. The service ID 202 field may contain, for example, a URL of the e-service, an e-service name, and/or any additional information necessary to identify and locate the e-service. The caching properties 204 field may record one or more caching properties for the e-service identified in the service ID 202 field of the same service cache record 200. The caching properties may indicate the caching ability and caching characteristics of the e-service, which determine what portions of the e-service may be downloaded, cached, and executed on the service caching POP 104.

For example, a business card e-service hosted on the host server 112 can indicate a caching property of “none,” “user data only,” or “all e-service data.” The caching property “none” may indicate that the business card e-service object code can be downloaded and executed on the service caching POP 104, but that none of the data associated with the business card e-service is to be downloaded. The caching property “user data only” may indicate that, in addition to the object code, the user's user data (e.g., the business cards the user created in his or her account) can be downloaded and cached on the service caching POP 104. The caching property “all e-service data” may indicate that the object code and all the data for the business card e-service can be downloaded and cached on the service caching POP 104.

In another example, a travel e-service hosted on the host server 112 can indicate a caching property of “none” or “location specific.” The caching property “none” may indicate that the travel e-service object code can be downloaded and executed on the service caching POP 104, but that none of the data associated with the travel e-service is to be downloaded. The caching property “location specific” may indicate that, in addition to the object code, data and information relevant to a specific location can be downloaded and cached on the service caching POP 104. For example, the service caching POP 104 administrator may enter the city or cities where the service caching POP 104 is located. This information may then be stored and used to download the travel e-service data and information applicable to the specified city or cities (e.g., the locations serviced by the service caching POP 104).

In one embodiment, the service caching POP 104 may provide a secure interface through which the administrator can administer the service caching POP 104. For example, using the secure interface, the administrator can specify one or more e-services (e.g., e-services that are related to other e-services that are identified in the service cache record 200) that should be cached on the service caching POP 104 in order to provide efficient and fast service to its users. The provided information and data may accordingly be stored and maintained in one or more service cache records 200.

In one embodiment, the service caching POP 104 may periodically transmit the cached data to the host server 112 from which the data was previously downloaded (e.g., the host server 112 hosting the appropriate e-service). For example, the service caching POP 104 may periodically transmit the cached business card e-service data to the host server 112 hosting the business card e-service. In one embodiment, the service caching POP 104 may monitor a user's access of a cached e-service. The service caching POP 104 may then transmit any cached data subsequent to detecting that the user is no longer accessing the e-service. In another embodiment, the service caching POP 104 may transmit, for example, every one-half hour, every hour, every six hours, etc., the cached data to the appropriate host server 112.

In one embodiment, the in cache 206 field indicates whether the corresponding e-service (i.e., the e-service identified in the service ID 202 field of the same record) is currently cached in the POP cache 108. The download time 208 field indicates the time the e-service was downloaded onto the service caching POP 104. The last access time 210 field indicates the time the e-service was most recently accessed by a user. For example, this may be the time the e-service most recently executed on the service caching POP 104. The age limit 212 field specifies an idle or inactive time duration, after which the e-service is to be purged from the service caching POP 104, and in particular, the POP cache 108. For example, if a cached e-service has not been accessed by a user for the time period specified in its age limit 212 field, the service caching POP 104 purges the e-service from the POP cache 108.

### Method for Service Caching On-Demand

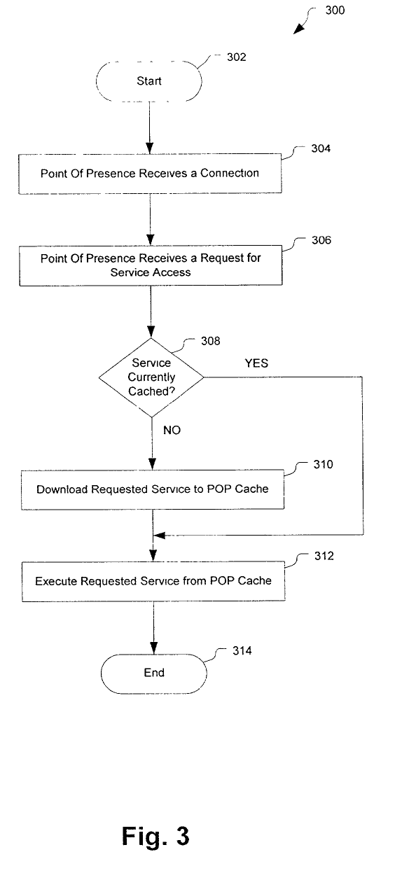

FIG. 3 is a flow chart of an exemplary method 300 by which an e-service is accessed, according to one embodiment. Beginning at a start step 302, the service caching POP 104, and in particular, the POP 106 component of the service caching POP 104, receives a connection from an application or a device at step 304. At step 306, the service caching POP 104 receives a request, for example, from the application or device connecting or connected to the POP 106, to access an online service (e.g., e-service). For example, a user may execute a browser on his or her user computer 114 and connect to the service caching POP 104. The user may then request to access an online service, such as, by way of example, an electronic calendar service that conforms to HP's e-speak specifications.

At step 308, the service caching POP 104, and in particular, the service caching system 102 component of the service caching POP 104, checks to see if the requested online service is currently cached in the POP cache 108. Continuing the prior example, the service caching system 102 can check the service ID 202 field of the service cache records 200 for the requested electronic calendar service. In one embodiment, if the requested online service is not listed in any of the service ID 202 fields (e.g., a service cache record 200 does not exist for the requested online service), the service is not downloadable onto the service caching POP 104. If a service cache record 200 for the requested electronic calendar service is found, the service caching system 102 can check the in cache 206 field to determine if the electronic calendar service is currently stored on the POP cache 108.

If, at step 308, the requested online service is a downloadable service (as may be determined from the service ID 202 field) but is not currently cached in the POP cache 108 (as may be determined from the in cache 206 field), then, at step 310, the service caching system 102 downloads the requested online service from, for example, the host server 112 hosting the online service. The service caching system 102 determines the components of the requested online service to request and download from the caching properties 204 field of the service cache record 200. In one embodiment, the service caching system 102 sets the in cache 206 field to indicate that the online service is locally stored in POP cache 108. The service caching system 102 may appropriately determine the time the online service was downloaded and store the determined time in the download time 208 field, as well as establish and store the time last accessed in the last access time 210 field.

In one embodiment, the service caching system 102 establishes a network connection through, for example, the Internet 110 with the host server 112. The service caching system 102 may then download the requested online service components using protocols such as, by way of example, TCP/IP, HTTP, a data transfer protocol conforming to HP's e-speak specification, and the like.

Continuing the prior example, the electronic calendar service may be found in a service ID 202 field in a service cache record 200, and the corresponding in cache 206 field may indicate that the electronic calendar service is not currently in the POP cache 108. Furthermore, the caching properties 204 field may indicate that only the object code, and none of the data, is downloadable onto the service caching POP 104. Here, the service caching system 102 can connect to the host server 112 hosting the electronic calendar service and request the electronic calendar service object code. The service caching system 102 can then store the electronic calendar service object code in POP cache 108.

If, at prior step 308, the requested online service is currently cached in POP cache 108, or subsequent to downloading and caching the requested online service (step 310), the service caching system 102 executes the requested online service from the POP cache 108 at step 312. Subsequent to executing the requested online service, the service caching system 102 ends at step 314. Otherwise, if the requested online service is a service that is not downloadable, the service caching POP 104 provides the POP 106 functions, and the requested online service is executed, for example, on the host server 112 hosting the requested online service.

Continuing the prior example, the service caching system 102 executes the electronic calendar service object code from the service caching POP 104. Because none of the data was downloaded, the service caching system 102 interacts with the host system to obtain the data as necessary. For example, the user may have requested to view his or her appointment schedule for the current week. The service caching system 102, subsequent to receiving the user request, can obtain the data for the user's appointment schedule information from the host system. The service caching system 102 can then incorporate the received data into the electronic calendar service object code to display the user's appointment schedule.

### Method for Configuring Caching Properties

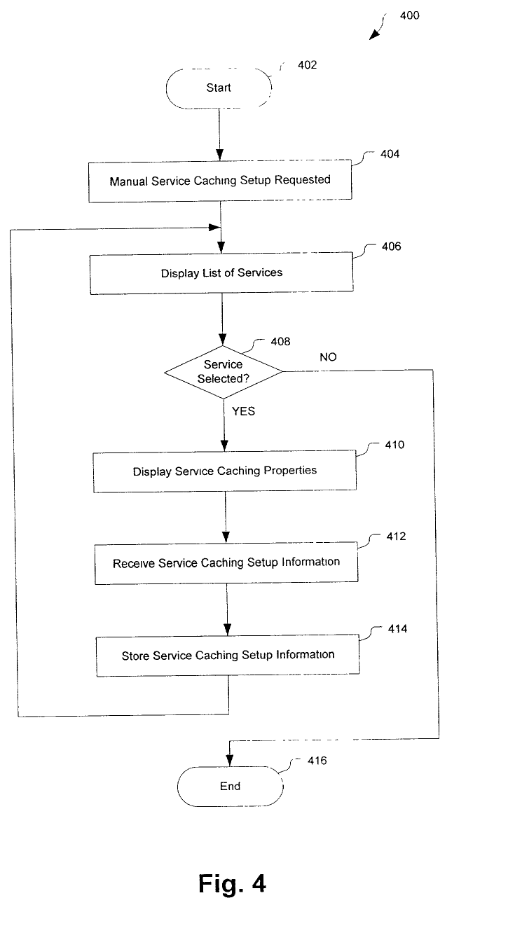

FIG. 4 is a flow chart of an exemplary method 400 by which service caching is manually configured, according to one embodiment. Beginning at a start step 402, the service caching system 102 receives a request to manually set-up one or more service caching properties at step 404. The service caching system 102 may provide a secure interface through which an administrator of the service caching POP 104 can manually configure service caching parameters and properties. For example, a service caching POP 104 administrator may provide an identification and password to access the service caching POP 104. Through the interface, the administrator can request an option to manually configure the caching properties for one or more e-services. Although the following discusses many steps as being performed by a human user (i.e., administrator) interacting with the service caching system 102 or the service caching POP 104, it should be understood that the same steps could be performed automatically by service caching system 102 or service caching POP 104, for example, by communicating with a host server 112 hosting a desired e-service.

At step 406, the service caching system 102 displays, for example, in a window, a list of e-services (e.g., downloadable online services) from the service ID 202 field of the service cache records 200. The service caching system 102 may provide the administrator an option to, for example, select one or more of the listed e-services or to select an option to enter a new e-service into the service caching POP 104. If the administrator selects the option to enter a new e-service, the service caching system 102 may provide one or more wizards through which the administrator can input the necessary information, such as, by way of example, the service ID 202, the caching properties 204, and the age limit 212, to create a service cache record 200 for the e-service.

At step 408, the service caching system 102 determines if one or more of the displayed e-services are selected, for example, by the administrator. If none of the displayed e-services are selected, or if the administrator selects, for example, a “quit” or “exit” option, the service caching system 102 ends at step 416. If the service caching system 102 determines that a displayed e-service is selected, the caching properties associated with the selected e-service are displayed at step 410. The service caching system 102 may display the service caching properties in, for example, one or more widows, and may provide options to add, delete, or otherwise modify one or more of the service caching properties. For example, the service caching system 102 retrieves the caching properties from the caching properties 204 field of the service cache record 200 for the selected e-service.

At step 412, the service caching system 102 receives the service caching information input by the administrator. In one embodiment, the e-service provider (e.g., the entity providing the e-service) determines the service caching properties for the e-service. For example, the e-service provider may determine that the e-service object code and the requesting user data are downloadable by the service caching system 102. The service caching POP 104 administrator may then input this information into the service caching system 102. In another embodiment, some or all of the service caching properties may be negotiated between the e-service provider and the service caching POP 104 provider.

At step 414, the service caching system 102 stores the service caching information and data in the service cache record 200 for the selected e-service. For example, service caching system 102 stores the service caching properties input by the administrator in the caching properties 204 field. In another example, an administrator may have selected an option to provide or modify an age limit parameter for a business card e-service, and entered an age limit of twenty-four hours. Service caching system 102 can then store the input twenty-four hours in the age limit 212 field in the service cache record 200 for the business card e-service. The service caching system 102, having stored the input information, returns to step 406 to process additional input from the administrator.

### Method for Aging a Cached Service

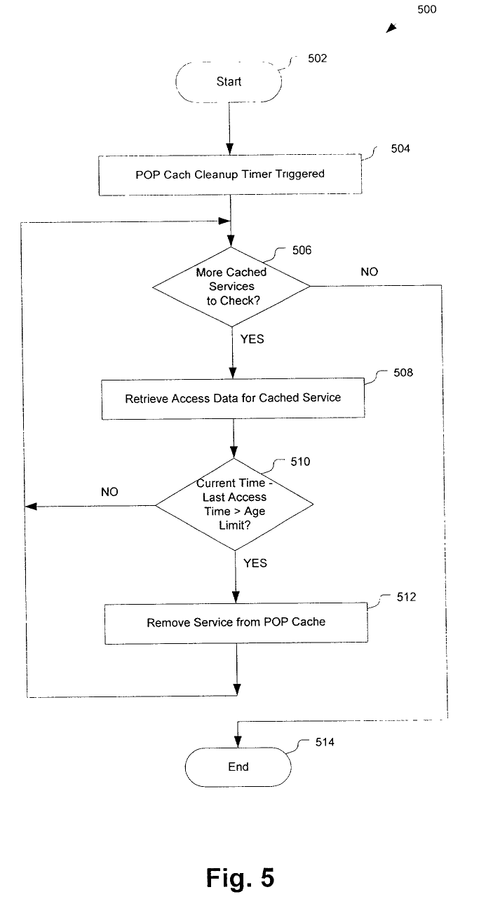

FIG. 5 is a flow chart of an exemplary method 500 for aging a cached service, according to one embodiment. At a start step 502, the service caching system 102 determines if it is time to age the one or more online services that are cached in the POP cache 108. In one embodiment, a cleanup software module periodically executes in the service caching system 102. The cleanup software module may be triggered to execute by a cleanup timer and checks the age of each cached online service. For example, the cleanup timer may be set to trigger the execution of the cleanup software module every two hours.

At step 504, the cleanup software module starts executing in the service caching system 102. At step 506, the cleanup software module in the service caching system 102 determines if there is a cached online service to process. For example, the cleanup software module determines if there are more service cache records 200 to check. If there are no more cached online services to process (e.g., all the cached on-line services have been processed or there are currently no cached online services), then the cleanup software module ends at step 514.

If, at step 506, there is a cached online service to process, the cleanup software module retrieves the access data for the cached online service at step 508. For example, the cleanup software module identifies the service cache record 200 for the cached online service, and from the record, retrieves the contents of the last access time 210 field (the time the cached online service was last accessed) and the contents of the age limit 212 field (the inactive time before the cached online service is to be purged from the local cache).

At step 510, the cleanup software module calculates the length of time since the cached online service has been last accessed (e.g., current time-last accessed time). The cleanup software module then compares this calculated time and the age limit (the contents of the age limit 212 field). If the cached online service has not been accessed (e.g., utilized, executed, etc.) for a time duration greater than the age limit, the cleanup software module purges the cached online service from the POP cache 108 at step 512. Otherwise, the online service remains cached in POP cache 108 (e.g., the cached online service has not aged enough to be purged). The cleanup software module then returns to step 506 to process the remaining cached online services. In one embodiment, the cleanup software module may inform the host server 112 hosting the purged online service that the online service is no longer cached in the POP cache 108.

### Method for Updating a Cached Service

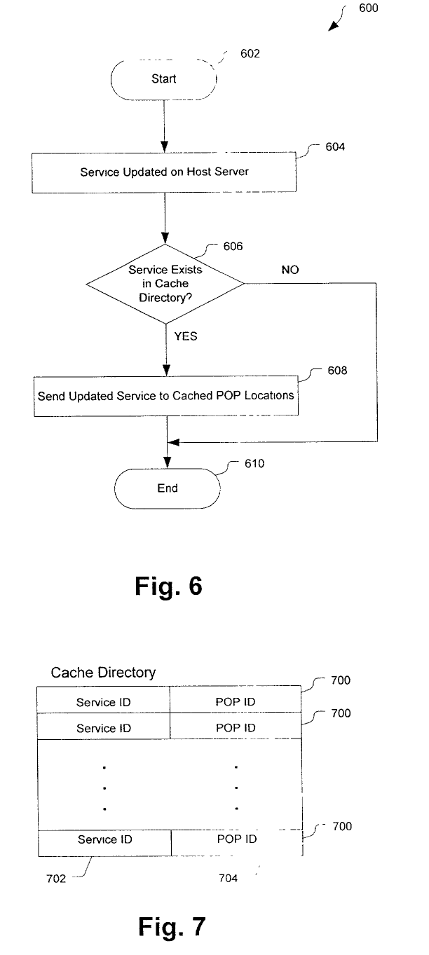

FIG. 6 is a flow chart of an exemplary method 600 for updating a cached service, according to one embodiment. Beginning at a start step 502, a host server 112 hosting an online service that may be locally cached on a service caching POP 104 determines that the online service has been updated on the host server 112 at step 604. In one embodiment, the online service may execute an update module whenever the online service is updated. For example, when an online service is updated by a newer version (e.g., a newer version of the online service is loaded on the host server 112), the online service, for example, as part of the load process, may cause the update module to execute.

At step 606, the update module determines if a prior version of the updated online service is cached on one or more service caching POPs 104. In one embodiment, the update module can check one or more cache directory records 700 to determine if, for example, a prior version of the updated online service is currently cached on a service caching POP 104.

FIG. 7 is a representation of one embodiment of an exemplary cache directory record 700. The host server 112 may maintain information and data regarding the online services that are currently cached on the service caching POPs 104 in one or more cache directory records 700. In one embodiment, the host server 112 may create a cache directory record 700 whenever an online service is downloaded by a service caching POP 104. By way of example, two fields are illustrated in each cache directory record 700 comprising a service ID 702 field and a POP ID 704 field. The service ID 702 field identifies the online service hosted on the host server 112 that is currently cached on a service caching POP 104. The POP ID 704 field identifies the service caching POP 104 that is caching the online service that is identified in the service ID 702 field of the same cache directory record 700. In another embodiment, the host server 112 can remove a cache directory record 700 that records that an online service is currently cached on a service caching POP 104 when informed by the service caching POP 104 that the online service is no longer cached in the POP cache 108.

Referring again to FIG. 6, if, at step 606, a prior version of the updated online service is not currently cached on a service caching POP 104 (e.g., a cache directory record 700 recording this event is not found), the update module ends at step 610. If a prior version of the updated online service is currently cached, then, at step 608, the update module transmits the updated online service to the one or more service caching POPs 104 that are currently caching a prior version of the updated online service. For example, the update module may identify the one or more service caching POPs 104 from the POP ID 704 field of the cache directory records 700. The update module then ends at step 610.

In one embodiment, the host server 112 hosting an online service that may be locally cached on a service caching POP 104 may also update the data associated with the online service on the service caching POP 104. For example, the host server 112 may detect that the data associated with a cached online service has been updated, for example, on the host server 112 subsequent to the time the data was downloaded and cached on a service caching POP 104. The host server 112 can then, adhering to the caching properties for the online service, transmit the updated data to the service caching POP 104 caching the online service and the data.

As described herein, the present invention in at least one embodiment facilitates an efficient utilization of network resources by reducing the amount of network traffic associated with accessing an online service. One embodiment of the present invention provides a local POP that caches one or more online services requested by one or more users. The local POP downloads the one or more online services over a network from its respective host computer. The local POP then executes the cached online services from its cache memory, thus, reducing the potential for network bottlenecks and the amount of network traffic to the host computers.

In at least one embodiment, the present invention provides faster access to an online service. When a user requests to access an online service through a local POP, the local POP determines if the requested online service is currently cached in local memory.

If it is, the local POP executes the locally cached copy of the online service. If it is not cached, and the requested online service is cacheable, the local POP downloads the online service from its host computer over a network. The local POP then caches the online 30 service and executes it from local memory, thus reducing the amount of network communication associated with the user's access of the online service and increasing performance.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method for caching an online service on a local point of presence, the online service being hosted on a remote host computer, the method comprising:
receiving a request, at a local point of presence, to access an online service;
determining if the requested online service is locally stored on the local point of presence;
in response to determining that the requested online service is not locally stored, downloading the requested online service from a remote host computer hosting the requested online service; and
storing the downloaded online service on the local point of presence.

2. The method of claim 1 further comprising determining if the requested online service is downloadable by the local point of presence.

3. The method of claim 1 further comprising executing the requested online service on the local point of presence.

4. The method of claim 1, wherein the requested online service is locally stored in cache memory.

5. The method of claim 1, wherein the requested online service conforms to HP's e-speak specifications.

6. The method of claim 1, wherein downloading the requested online service comprises downloading the online service object code.

7. The method of claim 1, wherein downloading the requested online service comprises downloading data associated with the requested online service.

8. The method of claim 1 further comprising:
maintaining an age limit for the requested online service;
determining an age of the requested online service locally stored on the local point of presence, the age being a time duration since the online service was last accessed; and
in response to determining that the age exceeds the age limit, removing the locally stored online service from the local point of presence.

9. The method of claim I further comprising receiving one or more caching properties for a locally stored online service.

10. A computer-readable storage medium having stored thereon computer instructions that, when executed by a computer, cause the computer to:
receive a request to access an online service;
determine if the requested online service is locally stored on a local point of presence;
in response to determining that the requested online service is not locally stored, download the requested online service from a remote host computer hosting the requested online service to the local point of presence; and
store the downloaded online service on the local point of presence.

11. The computer-readable storage medium of claim 10, wherein the computer is a component of the local point of presence.

12. The computer-readable storage medium of claim 10, wherein the computer instructions that receive a request to access an online service further comprise computer instructions that, when executed by a computer, cause the computer to determine if the requested online service is downloadable by the local point of presence.

13. The computer-readable storage medium of claim 10, wherein the computer instructions that receive a request to access an online service further comprise computer instructions that, when executed by a computer, cause the computer to execute the requested online service on the local point of presence.

14. The computer-readable storage medium of claim 10, wherein the requested online service is locally stored in cache memory.

15. The computer-readable storage medium of claim 10, wherein the requested online service conforms to HP's e-speak specifications.

16. The computer-readable storage medium of claim 10, wherein the downloaded online service comprises the online service object code.

17. The computer-readable storage medium of claim 10, wherein the downloaded online service comprises the data associated with the online service.

18. The computer-readable storage medium of claim 10, wherein the computer instructions that receive a request to access an online service further comprise computer instructions that, when executed by a computer, cause the computer to:
maintain an age limit for the requested online service;
determine an age of the requested online service locally stored on the local point of presence, the age being a time duration since the online service was last accessed; and
in response to determining that the age exceeds the age limit, remove the locally stored online service from the local point of presence.

19. The computer-readable storage medium of claim 10, wherein the computer instructions that receive a request to access an online service further comprise computer instructions that, when executed by a computer, cause the computer to receive one or more caching properties for a locally stored online service.

20. A service caching system for locally storing a requested online service, the online service being hosted on a remote host computer, the system comprising:
a means for maintaining a record of a plurality of online services locally stored on a local point of presence;
a means for receiving a request to access an online service;
a means for determining if the requested online service is locally stored on the local point of presence;
in response to determining that the requested online service is not locally stored, a means for downloading the requested online service from a remote host computer hosting the requested online service; and
a means for storing the downloaded online service on the local point of presence.
